(19) United States
(12) Patent Application Publication
(10) Pub. No.: US 2003/0018683 A1
(43) Pub. Date: Jan. 23, 2003

(54) Method, system and program for deleting work flow item

(76) Inventors: Yutaka Nara, Ebina (JP); Kazuyuki Ichikawa, Sagamihara (JP); Isamu Adachi, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/196,282

(22) Filed: Jul. 17, 2002

(30) Foreign Application Priority Data
Jul. 17, 2001 (JP) 2001-216292

(51) Int. Cl. G06F 9/00

(52) U.S. Cl. 709/102

(57) ABSTRACT

In a workflow system, control is performed such that a process instance and process instance-related data will be simultaneously deleted. This control makes unnecessary a deletion work of the process instance-related data by handwork which differs from a deletion work of the process instance, thereby reducing operating loads of the system. When an administrator terminal makes a process instance deleting request to a workflow server, a process instance managing function selects, from a process instance managing table, a process instance to be deleted. The process instance managing function calls a deletion time processing function on each selected process-instance basis. Based on a specified deletion-time-processing definition, the deletion time processing function calls either a database management system or an application controlling function, thereby performing the processing using the process instance-related data.

### BACKGROUND OF THE INVENTION

The present invention relates to technologies of a workflow system for processing a workflow with the use of computers. More particularly, it relates to a workflow system suitable for reducing operating loads, its process instance deleting method, and a program corresponding to the method.

In a workflow system, the utilization of a computer network makes it possible to effectively promote the flow of a series of work tasks. For example, the use of the workflow system circulates a slip to be read among a plurality of persons in charge, thereby allowing the implementation of a sales management, an accounting management, or the like.

In the workflow system, it is a common practice that the flow of the tasks is managed in a concentrated manner, and data such as the slip is managed using an application database or an application program. In a workflow system disclosed in, e.g., J-PA-11-66164, a workflow participant receives a work slip from a workflow server, then registering data on the work into the application database so as to perform the updating.

Also, in another example, as is disclosed in JP-A-2000-207474, unit task included in a series of work tasks in a workflow is executed using the application program such as a word processor, a spread sheet, or an estimate calculating application, and information on the work tasks is stored into the application database.

In the workflow systems as described above, a process instance is created every time a workflow is started. Moreover, every time each person in charge performs a processing on the process instance, the data on the process instance is accumulated into the application database or the application program.

In the above-described prior arts, there has been provided a function of simultaneously registering/updating a process instance managed in a workflow system and data managed in relation to the process instance in the application database or the application program. No consideration, however, has been given to a point of simultaneously deleting the process instance and the data related to the process instance. This has required that, when deleting the process instance in the workflow, a system administrator should delete the above-described process instance-related data by handwork. At this time, committing an error at this handwork brings about a damage in the consistency between the process instance in the workflow and the process instance-related data, thereby, depending on the cases, exerting serious influences on the system.

This has resulted in a problem that a work for ensuring the consistency between these pieces of data has become a tremendous load onto the system administrator.

### SUMMARY OF THE INVENTION

It is an object of the present invention to solve the problems in the above-described prior art, to exclude the error committed at the handwork by the system administrator, and thereby to provide a workflow system capable of reducing operating and managing loads, its process instance deleting method, and a program implementing the method.

In order to accomplish the above-described object, according to one aspect of the present invention, a workflow system that, using a computer, performs a workflow processing of promoting work tasks while circulating a process instance includes the following configuration components: a deletion-time-processing definition storing unit for storing the definition of a processing to be performed at the time of deleting a process instance, and a deletion time processing unit for executing the above-described stored processing at the time of deleting the process instance.

Also, according to another aspect of the present invention, a workflow system that, using computers, performs a workflow processing of promoting work tasks while circulating a process instance includes the following configuration components: a process instance managing table that, in order to manage each process instance, holds an identifier for identifying each process instance, the state of each process instance, and the definition number of each process instance, a deletion-time-processing definition storing unit for storing the definition of a processing to be performed at the time of deleting a process instance on each process-instance definition number basis, and a deletion time processing unit. Here, the deletion time processing unit receives a process instance deleting request, makes reference to the above-described process instance managing table, selects a process instance that is the deletion target, reads, from said deletion-time-processing definition storing unit, and executes a deletion-time-processing definition corresponding to the definition number of the selected process instance, and deletes the selected process instance from said process instance managing table.

Also, according to still another aspect of the present invention, in said workflow system, said process instance managing table holds the state of each process instance as to whether each process instance had been completed or is under execution. Moreover, when selecting said process instance that is the deletion target, a process instance the state of which is “completed” is selected as the deletion target from the process instance managing table.

Also, in said workflow system according to still another aspect of the present invention, said process instance managing table holds a point-in-time at which each process instance had been terminated. Moreover, when selecting said process instance that is a deletion target, reference is made from the process instance managing table to the point-in-time at which each process instance had been terminated. In addition, a process instance from the termination point-in-time of which a predetermined time has elapsed is selected as the deletion target.

Also, in the above-described workflow system according to still another aspect of the present invention, said deletion-time-processing definition storing unit has stored a processing target and a processing content of the processing to be performed at the time of deleting the process instance. Furthermore, said deletion time processing unit, which will read and execute said deletion-time-processing definition, executes the processing of said processing content towards said processing target.

Also, in said workflow system according to still another aspect of the present invention, said processing target by the deletion-time-processing definition is either a database or an application. If the processing target is the database, said processing content is an instruction statement of the deletion time processing towards the database. If the processing target is the application, the processing content is an instruction statement of the deletion time processing towards the application.

Also, in said workflow system according to still another aspect of the present invention, said processing content includes a variable into which, when the processing content is executed, a value on the process instance corresponding thereto will be substituted.

Other objects, features and advantages of the invention will become apparent from the following description of the embodiments of the invention taken in conjunction with the accompanying drawings.

### BRIEF DESCRIPTION OF THE DRAWINGS

FIG. 1 illustrates an example of the configuration diagram of a workflow system according to an embodiment of the present invention;

FIG. 2 illustrates an example of the configuration diagram of a process instance managing table included in a workflow server;

FIG. 3 illustrates a configuration example of a deletion-time-processing definition included in the workflow server;

FIG. 4 is a flowchart for showing an example of the processing operation by a process instance managing function included in the workflow server;

FIG. 5 is a flowchart for showing an example of the processing operation by a deletion time processing function included in the workflow server; and

FIG. 6 illustrates an example of a process instance deletion processing according to the embodiment of the present invention.

### DESCRIPTION OF THE EMBODIMENTS

Hereinafter, referring to the drawings, the explanation will be given below concerning an embodiment of the present invention.

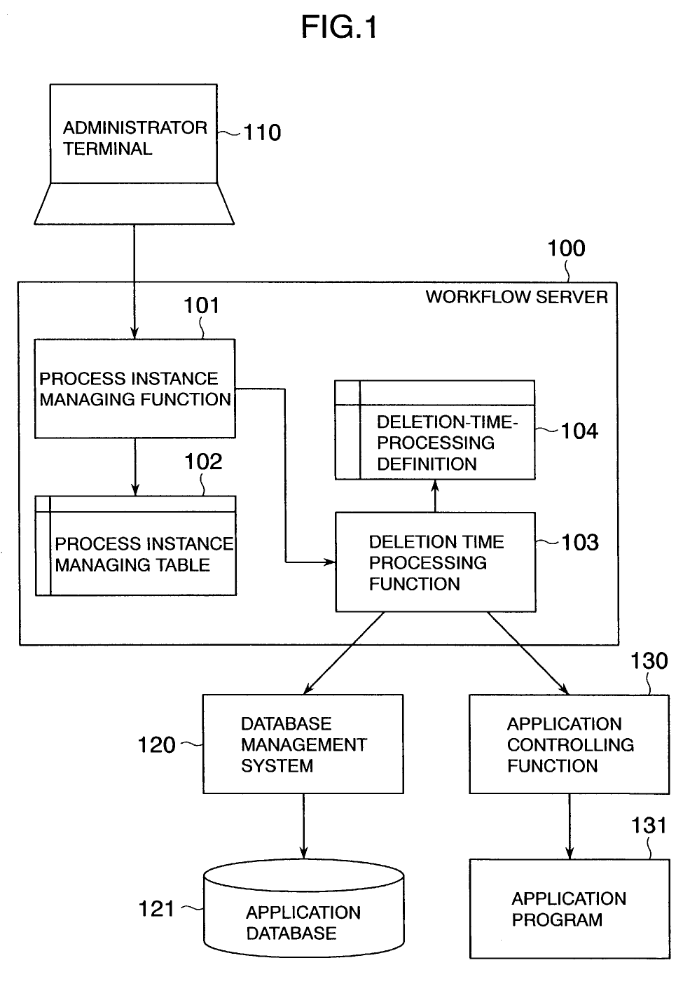

FIG. 1 illustrates the configuration diagram of a workflow system according to the embodiment of the present invention. This workflow system includes a workflow server 100 and an administrator terminal 110 that a system administrator uses in order to issue an operating instruction to the workflow server 100. A database management system 120 for managing an application database 121 is connected to the workflow server 100. Also, the workflow server 100 calls an application controlling function 130, which makes it possible to cause an application program 131 or the like to execute a processing. Here, the administrator terminal 110 may be the identical machine to the workflow server 100, or the administrator terminal 110 may exist in each of two machines connected via a network.

The workflow server 100 includes a process instance managing function 101 and a deletion time processing function 103. The process instance managing function 101 manages process instances, using a process instance managing table 102. The deletion time processing function 103 determines the processing at the time of deleting a process instance, using a deletion-time-processing definition 104. Also, based on the definition content of the deletion-time-processing definition 104, the deletion time processing function 103 calls the database managing system 120 and the application controlling function 130. In response to the call by the deletion time processing function 103, the database managing system 120 executes a processing towards the application database 121, using an SQL or the like. Similarly, the application controlling function 130 executes a processing towards the application program 131, using an API (: Application Programming Interface) or the like included in the application program 131.

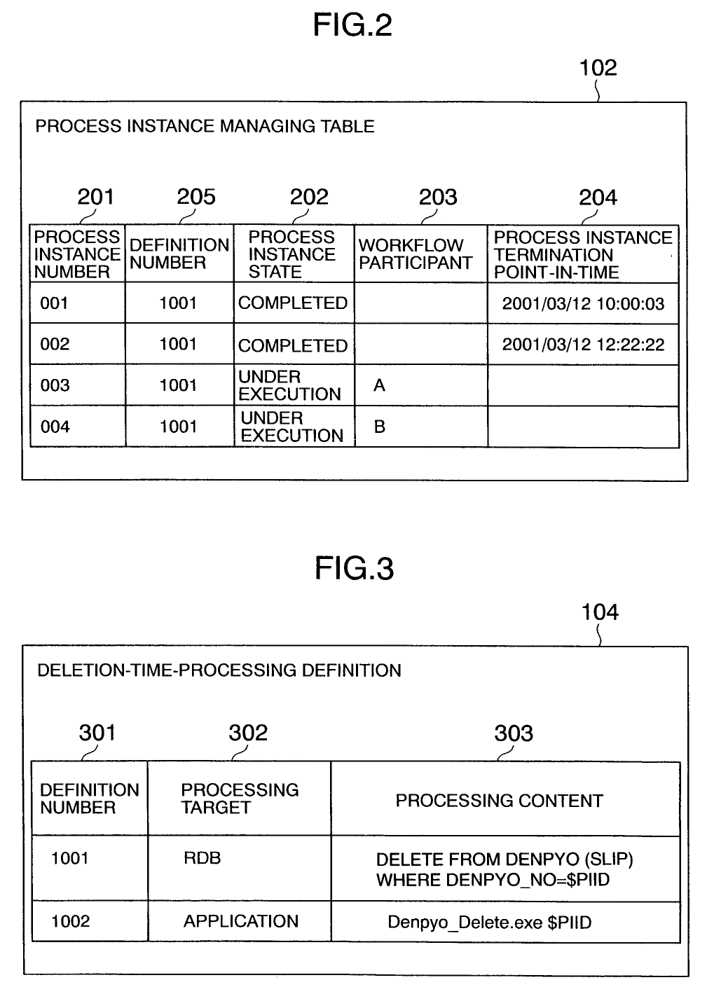

FIG. 2 is a diagram for illustrating a configuration example of the process instance managing table 102 included in the workflow server 100 in FIG. 1.

The process instance managing table 102 illustrated in FIG. 2 includes the following respective items: process instance numbers 201, process instance states 202, workflow participants 203, process instance termination points-in-time 204, and definition numbers 205. The process instance numbers 201 are identifiers managed uniquely on each process-instance basis, and the process instance states 202 indicate whether the individual process instances are under execution or have been completed. Also, the workflow participants 203 indicate allocations of the workflow participants who should process the process instances that are under execution at present, and the process instance termination points-in-time 204 indicate points-in-time at which the individual process instances had been terminated. The definition numbers 205 indicate definition numbers of process-instance definitions to be managed in the workflow system.

When, in FIG. 1, a process instance deleting request is executed from the administrator terminal 110 towards the workflow server 100, the process instance managing function 101 makes reference to the process instance managing table 102. Next, the function 101 selects, as process instances of deletion targets, the process instances the process instance states 202 of which in FIG. 2 are “completed”, or the process instances from the process instance termination points-in-time 204 of which a predetermined time (which can be specified by the administrator) has elapsed.

FIG. 3 is a diagram for illustrating a configuration example of the deletion-time-processing definition 104 included in the workflow server 100 in FIG. 1.

The deletion-time-processing definition 104 in FIG. 3 includes the respective items of definition numbers 301, processing targets 302, and processing contents 303. The definition numbers 301 indicate definition numbers (which are the same as the definition numbers 205 in FIG. 1) of workflows. Namely, it is stipulated that the flows of the work tasks to be implemented in the workflow system differ for each definition number. The processing targets 302 indicate which of the database management system 120 and the application controlling function 130 the deletion time processing function 103 in FIG. 1 will call. In the present example, “RDB” indicating the database management system is set up with respect to the definition number “1001”. Also, “application” indicating the application controlling function is set up with respect to the definition number “1002”. The processing contents 303 indicate the processing contents to be actually performed at the time of the deletion. In the present example, the SQL statement to be performed towards the database management system 120 in FIG. 1 is described with respect to the definition number “1001”. Also, the name of a program to be executed as the application controlling function in FIG. 1 is described with respect to the definition number “1002”.

The variable “$PIID” is included in the SQL statement described in the processing content 303 with respect to the definition number “1001” in the present example. This “$PIID” indicates the process instance number 201 of each process instance in the process instance managing table 102 in FIG. 2. When the deletion time processing function 103 is called with respect to each process instance in the process instance managing table 102, the “$PIID” makes it possible to perform the processing of data related to each process instance.

The process instance managing table 102 illustrated in FIG. 2 and the deletion-time-processing definition 104 illustrated in FIG. 3 are made related to each other by the definition numbers 205 and the definition numbers 301. For example, the deletion time processing towards the process instance of the process instance number “001” is the processing defined by the definition number “1001”. Namely, when performing the processing towards a process instance, the processing is performed by reading the processing content of the deletion time processing of the definition number corresponding to the process instance.

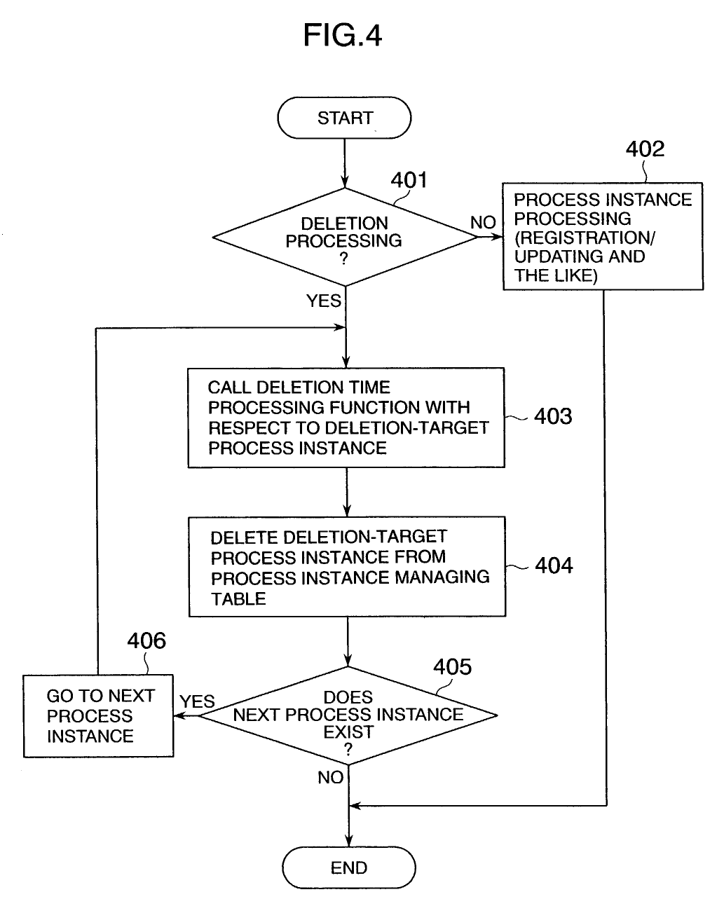

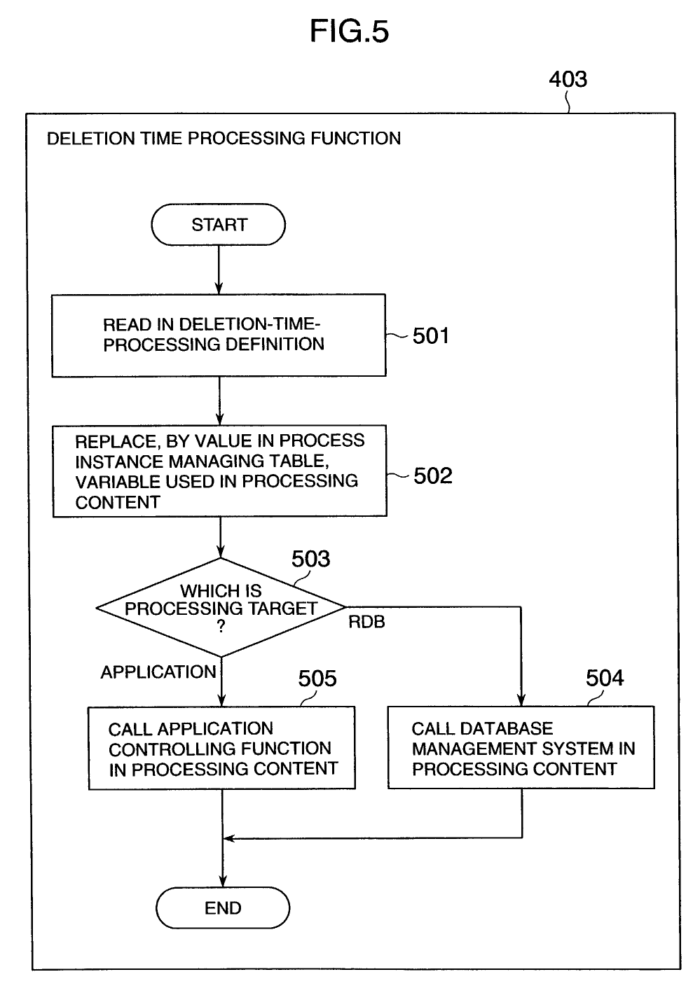

FIG. 4 is a flowchart for showing an example of the processing operation by the process instance managing function 101 included in the workflow server 100 in FIG. 1.

The process instance managing function 101 in the workflow server 100 in FIG. 1 makes a judgement as to whether the processing requested from the administrator terminal 110 is a deletion processing, or a processing other than the deletion such as a process instance registration or updating (step 401). In the case of the processing other than the deletion, each process instance processing is performed (step 402), then being ended.

In the case of the deletion processing, at first, the process instance management function 101 operates to reference the management table 102 and select a process instance relevant to delete therefrom. The deletion time processing function 103 in FIG. 1 is then called together with the process instance number of the process instance to be deleted (step 403). Next, the process instance becoming the deletion target is deleted from the process instance managing table 102 (step 404). Moreover, in the process instance managing table 102, the next process instance becoming the deletion target is searched for (step 405). If the next process instance has been found out, the next process instance is read in (step 406). Then, going back to the step 403, the same processing is repeated. Also, if, at the step 405, the next process instance of the deletion target has been not found out, the processing is ended.

FIG. 5 is a flowchart for showing an example of the processing operation by the deletion time processing function 103 included in the workflow server 100 in FIG. 1.

The deletion time processing function 103 in FIG. 1, which has been called at the step 403 in FIG. 4, performs the following processing: First, based on the definition number 301 of the workflow, the deletion-time-processing definition 104 is read in (step 501). If a variable indicating the value in the process instance managing table 102 is included in the processing content 303 of the deletion-time-processing definition 104 in FIG. 3, the variable portion is replaced by the value in the process instance managing table 102 (step 502). For example, in the case where, in the deletion-time-processing definition 104 in FIG. 3, the definition number “1001” has been read in, the variable “$PIID” included in the processing content 303 is replaced by the value of the process instance number 201 in the process instance managing table 102.

Next, based on a value of the processing target 302 in the deletion-time-processing definition 104 read in at the step 501, a judgement is made as to which of “RDB” and “application” should be selected as the processing target (step 503). In the case of selecting “RDB”, the database management system 120 in FIG. 1 is called together with the processing content where the variable has been replaced at the step 502, thereby performing the processing of the data related to the process instance (step 504). In the case of selecting “application”, the application controlling function 130 in FIG. 1 is called together with the processing content where the variable has been replaced at the step 502, thereby performing the processing of the data related to the process instance (step 505).

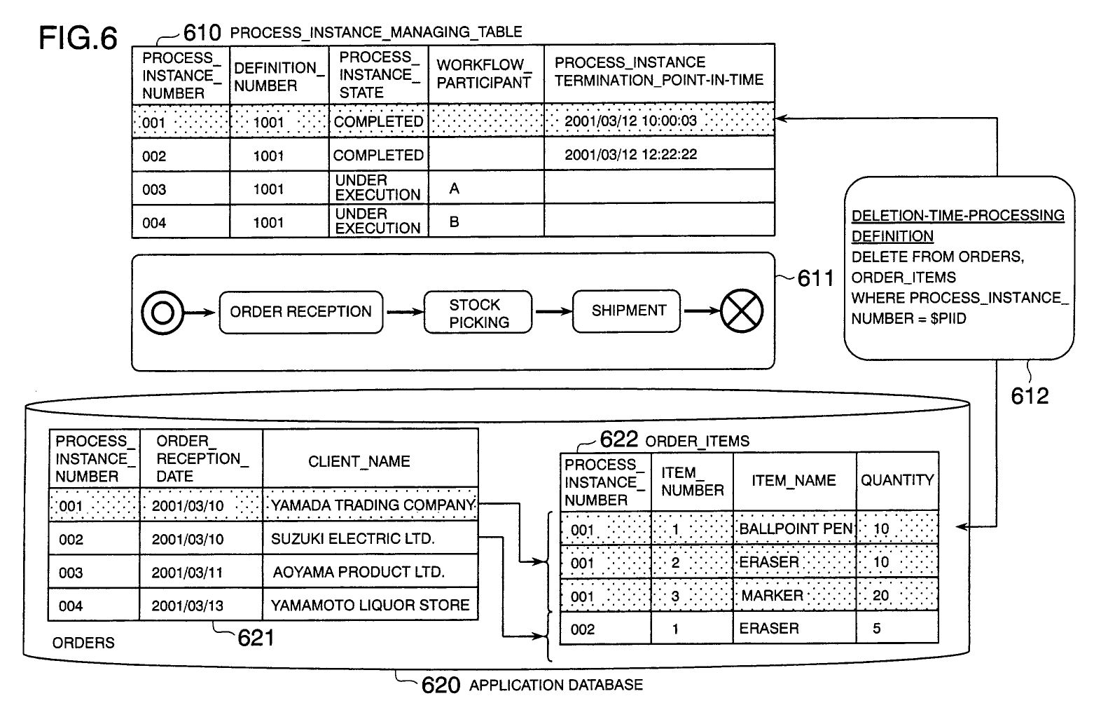

FIG. 6 is a diagram for illustrating a concrete example of the process instance deletion processing according to the embodiment of the present invention.

With respect to the definition of a workflow where the processing is developed in such a manner as “order reception→stock picking→shipment” as is illustrated in 611, the processing content described in the processing content of the deletion-time-processing definition with respect to the definition number “1001” of this workflow definition is assumed to be “DELETE FROM orders, order_items WHERE process_instance_number=$PIID” as is illustrated in 612. Also, the contents of the process instance managing table and the contents of the application database are assumed to be just as described in 610 and 620, respectively.

At first, when, in FIG. 1, a deleting request for deleting the process instance of the process instance number “001” is executed from the administrator terminal 110 towards the workflow server 100, the process instance managing function 101 makes reference to the process instance managing table 610, then selecting the record of the process instance number “001” as a process instance of the deletion target. Next, the function 101 calls the deletion time processing function 103 with respect to the deletion-target process instance. Here, the deletion-target process instance is the process instance of the process instance number “001”, and thus the deletion time processing function corresponding to this process instance number is the processing content described in the definition number “1001”. Accordingly, the deletion time processing function 103 replaces, by the value “001”of the process instance number, the variable “$PIID” included in the processing content “DELETE FROM orders, order_items WHERE process_instance_number=$PIID”. After that, the function 103 executes this processing content towards the processing target “RDB”, thereby deleting the records related to the process instance number “001” in the orders 621 and the order-items 622 within the application database 620. Subsequently, the function 101 deletes the record of the process instance number “001”, i.e., the deletion-target process instance, from the process instance managing table 610.

The above-described series of processings make it possible to simultaneously delete the process instance record of the process instance number “001” included within the process instance managing table 610 and the data records related thereto and included within the application database 620 (the record and the data records are the hatched portions in FIG. 6).

As having been explained so far, in the workflow system and its process instance deleting method of the present embodiment, the processing operation to be performed at the time of deleting a process instance is defined, and the defined processing operation is executed at the time of deleting the process instance. For example, the data records, which are related to the process instance to be deleted and included within the application database, are deleted. Otherwise, data on slip information or the like, which is related to the process instance to be deleted and included within the application program, is deleted.

This allows the implementation of the simultaneous deletion of the process instance and the data related to the process instance, thereby making unnecessary the work such as the deletion of the process instance-related data by handwork, which differs from the deletion of the process instance in the conventional workflow system. This, eventually, makes it possible to reduce the operating loads.

Incidentally, the present invention is not necessarily limited to the above-described embodiment explained using FIGS. 1 to 5, but is changeable in various ways within the scope that does not depart from its essence. For example, in the above-described embodiment of the present invention, the deletion time processing function 103 in FIG. 1, based on the deletion-time-processing definition 104, has called either the database management system 120 or the application controlling function 130. The other techniques, however, may also be employed where any one of three or more plural function blocks is called, or where, at one processing, a combination of two or more plural function blocks is called instead of calling one function block.

Also, in the above-described embodiment of the present invention, the SQL has been used for the database management system 120, and the general program call where the name of the program is specified has been used for the application controlling function 130. The other techniques, however, may also be employed where a Stored Procedure is used instead of the SQL, or where, instead of the program call, the program located in another machine is called using a RPC (: Remote Procedure Call), or where the program is called as a distributed object.

As having been explained so far, according to the present invention, when deleting a process instance in the workflow system, the process instance and the data related to the process instance can be deleted simultaneously. This makes unnecessary the deletion work of the process instance-related data by handwork, which differs from the deletion work of the process instance, thereby allowing a human-induced error to be excluded. This makes it possible to reduce the operating loads onto the system administrator or the like.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A workflow system for processing work tasks by circulating a process instance using a computer, comprising:
a deletion-time-processing definition storing unit for storing a definition of a processing to be performed when deleting a process instance, and
a deletion time processing unit for transmitting an instruction of executing said processing when deleting said process instance, the contents of said processing being stored in said deletion-time-processing definition storing unit.

2. A workflow system for performing a processing of promoting work tasks through circulation of a process instance using a computer, comprising:
a process instance managing table for holding an identifier for identifying each process instance, a state of each process instance, and a definition number of each process instance in order to manage each process instance,
a deletion-time-processing definition storing unit for storing a definition of a processing to be performed when deleting a process instance on said each process-instance definition number basis, and
a deletion time processing unit for receiving a process instance deleting request, making reference to said process instance managing table, selecting a process instance of a deletion target, reading, from said deletion-time-processing definition storing unit, and executing a deletion-time-processing definition corresponding to a definition number of said selected process instance, and transmitting an instruction of deleting said selected process instance from said process instance managing table.

3. The workflow system as claimed in claim 2, wherein said process instance managing table holds said state of each process instance as to whether each process instance had been completed or is under execution,
said deletion time processing unit, when selecting said process instance of said deletion target, selecting a process instance said state of which is “completed” as said deletion target from said process instance managing table.

4. The workflow system as claimed in claim 2, wherein said process instance managing table holds a point-in-time at which each process instance had been terminated,
said deletion time processing unit, when selecting said process instance of said deletion target, making reference from said process instance managing table to said point-in-time at which each process instance had been terminated, and selecting, as said deletion target, a process instance from said termination point-in-time of which a predetermined time has elapsed.

5. The workflow system as claimed in claim 2, wherein said deletion-time-processing definition storing unit has stored a processing target and a processing content of said processing to be performed when deleting said process instance,
said deletion time processing unit, when reading and executing said deletion-time-processing definition, executing said processing of said processing content towards said processing target.

6. The workflow system as claimed in claim 5, wherein said processing target by said deletion-time-processing definition is either a database or an application program,
said processing content being an instruction statement of said deletion time processing towards said database if said processing target is said database, said processing content being an instruction statement of said deletion time processing towards said application if said processing target is said application program.

7. The workflow system as claimed in claim 5, wherein said processing content includes a variable into which, when said processing content is executed, a value on said process instance corresponding thereto will be substituted.

8. The workflow system as claimed in claim 6, wherein said processing content includes a variable into which, when said processing content is executed, a value on said process instance corresponding thereto will be substituted.

9. A process instance deleting method for use in a workflow system for performing work tasks processing by circulating a process instance using a computer, comprising the steps of:
storing a definition of a processing to be performed when deleting a process instance, and
when deleting a process instance, determining a processing to be performed based on said stored definition for deleting said process instance based on said stored definition and executing the determined deleting processing.

10. A process instance deleting method for application to a workflow system which performs a processing of promoting work tasks by circulating a process instance using a computer, comprising the steps of:
storing an identifier for identifying each process instance, a state of each process instance, and a definition number of each process instance into a process instance managing table to manage each process instance,
storing, into a deletion-time-processing definition storing unit, a definition of a processing to be performed when deleting a process instance on said each process-instance definition number basis,
receiving a process instance deleting request, making reference to said process instance managing table, and selecting a process instance of a deletion target,
reading, from said deletion-time-processing definition storing unit, and executing a deletion-time-processing definition corresponding to a definition number of said selected process instance, and
deleting said selected process instance from said process instance managing table.

11. The process instance deleting method as claimed in claim 10, wherein said process instance managing table holds said state of each process instance as to whether each process instance had been completed or is under execution,
said step of selecting said process instance of said deletion target selecting a process instance said state of which is “completed” as said deletion target from said process instance managing table.

12. The process instance deleting method as claimed in claim 10, wherein said process instance managing table holds a point-in-time at which each process instance had been terminated,
said step of selecting said process instance of said deletion target making reference from said process instance managing table to said point-in-time at which each process instance had been terminated, and selecting, as the deletion target, a process instance from said termination point-in-time of which a predetermined time has elapsed.

13. The process instance deleting method as claimed in claim 10, wherein said step of storing said definition of said processing to be performed when deleting said process instance stores, into said deletion-time-processing definition storing unit, a processing target and a processing content of said processing to be performed when deleting said process instance,
said step of reading and executing said deletion-time-processing definition executing said processing of said processing content towards said processing target.

14. The process instance deleting method as claimed in claim 13, wherein said processing target by said deletion-time-processing definition is either a database or an application program,
said processing content being an instruction statement of said deletion time processing towards said database if said processing target is said database, said processing content being an instruction statement of said deletion time processing towards said application program if said processing target is said application program.

15. The process instance deleting method as claimed in claim 13, wherein said processing content includes a variable into which, when said processing content is executed, a value on said process instance corresponding thereto will be substituted.

16. The process instance deleting method as claimed in claim 14, wherein said processing content includes a variable into which, when said processing content is executed, a value on said process instance corresponding thereto will be substituted.

17. A program for implementing a method of deleting a process instance in a system for performing a processing of performing work tasks through circulating of a process instance using a computer, said method comprising the steps of:
receiving a process instance deleting request, making reference to a process instance managing table, and selecting a process instance of a deletion target, said process instance managing table having stored an identifier for identifying each process instance, a state of each process instance, and a definition number of each process instance,
reading, from a deletion-time-processing definition storing unit, and executing a deletion-time-processing definition corresponding to a definition number of said selected process instance, said deletion-time-processing definition storing unit having stored a definition of a processing to be performed when deleting a process instance on said each process-instance definition number basis, and
deleting said selected process instance from said process instance managing table.

18. The program as claimed in claim 17, wherein said process instance managing table holds said state of each process instance as to whether each process instance had been completed or is under execution,
said step of selecting said process instance of said deletion target selecting a process instance said state of which is “completed” as said deletion target from said process instance managing table.

19. The program as claimed in claim 17, wherein said process instance managing table holds a point-in-time at which each process instance had been terminated,
said step of selecting said process instance of said deletion target making reference from said process instance managing table to said point-in-time at which each process instance had been terminated, and selecting, as said deletion target, a process instance from said termination point-in-time of which a predetermined time has elapsed.

20. The program as claimed in claim 17, wherein said processing to be performed when deleting said process instance includes a processing target and a processing content of said processing to be performed when deleting said process instance,
said step of reading and executing said deletion-time-processing definition executing said processing of said processing content towards said processing target.

21. The program as claimed in claim 20, wherein said processing target by said deletion-time-processing definition is either a database or an application program,
said processing content being an instruction statement of said deletion time processing towards said database if said processing target is said database, said processing content being an instruction statement of said deletion time processing towards said application program if said processing target is said application program.

22. The program as claimed in claim 20, wherein said processing content includes a variable into which, when said processing content is executed, a value on said process instance corresponding thereto will be substituted.

23. The program as claimed in claim 21, wherein said processing content includes a variable into which, when said processing content is executed, a value on said process instance corresponding thereto will be substituted.
